(19) United States
(12) Patent Application Publication
(10) Pub. No.: US 2019/0283498 A1
(43) Pub. Date: Sep. 19, 2019

(54) WHEEL FOR VEHICLE

(71) Applicant: CLOVERGLADE LTD., Dublin 2 (IE)

(72) Inventors: Robert George BODILL, Woodstock (GB); Dana Bryan HOFFER, Media, PA (US)

(21) Appl. No.: 16/337,748

(22) PCT Filed: Sep. 28, 2017
(86) PCT No.: PCT/IB2017/055983

§ 371 Date: Mar. 28, 2019

Related U.S. Application Data
(60) Provisional application No. 62/401,786, filed on Sep. 29, 2016.

(51) Int. Cl. B60B 27/02; B62M 1/10; B60B 3/00; B62H 7/00

(52) U.S. Cl. CPC B60B 27/023; B62M 1/10; B62J 2099/0006; B62H 7/00; B60B 2200/47; B60B 3/002

(57) ABSTRACT

A wheel for a vehicle is provided. The wheel has a first rim support member having a first hub portion rotatably mounted on an axle, and a second rim support member having a second hub portion releasably rotatably mounted on the axle, the second rim support member being releasably secured to the first rim support member along a region spaced from the axle. A rim portion extends from at least one of the first rim support member and the second rim support member and is configured to support a tyre thereon. A flywheel is positioned between the first rim support member and the second rim support member and has a flywheel hub portion releasably rotatably mounted on the axle between the first hub portion and the second hub portion.

### CROSS-REFERENCE TO RELATED APPLICATIONS

This application claims the benefit of U.S. Provisional Patent Application No. 62/401,786, filed Sep. 29, 2016, the contents of which are incorporated herein by reference in their entirety.

### FIELD

The specification relates generally to vehicles. In particular, the following relates to a wheel for human-operated vehicles, and human-operated vehicles using the same.

### BACKGROUND OF THE DISCLOSURE

Learning to ride a bicycle, or other similar human-operated vehicle, is a challenge faced by young children (and some older ones). Similarly, riding a bicycle can be difficult for disabled persons who require continual assistance in order to maintain stability, or for elderly or other persons who have lost their aptitude for cycling or have a diminished sense of balance.

Prospective riders must develop awareness of what are, in essence, complex Newtonian principles of force-balance, gravity, torque, inertia and momentum. Only by continually adjusting weight and balance for the prevailing velocity and turn radius can one proficiently ride a bicycle for any distance. Starting a bicycle from a standing position is a particular challenge as the forward velocity needed to maintain balance has not yet been established. Likewise, turns are difficult for new riders as the weight and balance of the bicycle and rider shifts suddenly and may become difficult to control. It is not uncommon for new riders to jack-knife the bicycle wheel, causing both bike and rider to tumble over.

The usual time-tested approach to preparing children to ride by exposing them to the basic dynamics of a bicycle is the use of training wheels. Briefly, training wheels are typically a pair of small-diameter, hard rubber/plastic wheels attached by removable brackets to the rear axle. Training wheels, however, are inadequate because they do not simulate real, unrestricted bicycle movement. They incorrectly teach riders to balance by relying on the training wheels rather than actually learning to balance through weight manipulation. Moreover, training wheels inhibit riders from banking as they turn, forcing them into bad habits.

WO2007/005282A2 discloses a stabilizing system and method for two-wheeled vehicles (typically small, human-powered bicycles) that affords the rider no restriction on the full range of movements (banks, leans, etc.) common to bicycles, but that provides greater stability during turns and other manoeuvers so that an unintentional bank or tilt (potentially leading to a fall) is less likely, even at relatively slow speeds and start-up. A rotating mass of predetermined mass-value and radial mass-distribution is provided optionally coaxially with the front axle. The mass is supported on bearings so as to freewheel with respect to the rotation of the front wheel. As such it can be induced to spin significantly faster than the front wheel thereby generating a gyroscopic effect at the front wheel about the axle. This gyroscopic effect influences the steering of the wheel by the rider. Due to precession, the wheel tends to follow any excessive bank by the bicycle, ensuring that the rider can “steer-out-of” an unintentional tilt. Likewise, the gyroscopic effect limits the rider's ability to execute excessive steering, thereby preventing jack-knife movements.

The mass can be mounted on bearings that are themselves mounted over the centre hub of the bicycle wheel. The bicycle wheel is, in turn, mounted conventionally on a threaded axle that is attached to the front fork by opposing nuts. The mass of this embodiment is unpowered, and initially forced in to rotation by action of a helper (adult) as the rider starts the ride. It can be urged to rotate using a variety of permanently attached and/or detachable mechanisms.

Benefits such as stability provided by a rotating mass or “flywheel” contained in either the front or rear bicycle wheel have recently been discovered. The flywheel creates a beneficial stabilizing force for people learning to ride or that need continual riding assistance.

### SUMMARY OF THE DISCLOSURE

In one aspect, there is provided a wheel for a vehicle, comprising a first rim support member having a first hub portion rotatably mounted on an axle, a second rim support member having a second hub portion releasably rotatably mounted on the axle, the second rim support member being releasably secured to the first rim support member along a region spaced from the axle, a rim portion extending from at least one of the first rim support member and the second rim support member and configured to support a tyre thereon, and a flywheel positioned between the first rim support member and the second rim support member and having a flywheel hub portion releasably rotatably mounted on the axle between the first hub portion and the second hub portion.

The rim portion can extend from the first rim support member. The rim portion can be integrally formed with the first rim support member. The second rim support member can be releasably secured to the first rim support member adjacent the rim portion.

The second rim support member can be releasably secured to the first rim support member via at least one fastener adjacent the rim portion.

One of the first rim support member and the second rim support member can have at least one retaining feature within which the other of the first rim support member and the second rim support member fits and abuts. The first rim support member can comprise the at least one retaining feature, and the at least second rim support member can be releasably secured to the first rim support member via axial compression. The axial compression can be provided by a nut screwed on the axle.

The wheel can further comprise a motor coupled to the flywheel to control rotation of the flywheel about the axle. The motor can be secured to one of the first rim support member and the second rim support member, and can be releasably coupled to the flywheel. The second rim support member can be secured to a first side of the first rim support member, and the first rim support member can have a recess on a second side opposite the first side.

The wheel can further comprise a recess cover configured to enclose the recess. The wheel can have a motor located in the recess and coupled to the flywheel to control rotation of the flywheel about the axle, and a drive transmission extending from the motor, through the first rim support member, and to the flywheel to drive the flywheel. The wheel can have an audio speaker located in the recess. The wheel can have a processor configured to play audio instructions for removal of the flywheel via the audio speaker.

At least one of the first rim support member and the second rim support member can have a viewing aperture enabling viewing of the flywheel when positioned between the first rim support member and the second rim support member. The viewing aperture can be covered by an at least somewhat transparent material.

The motor can be actuated via at least one of a physical control switch located on a surface of the wheel, a wired connection to a locking mechanism securing the first cover to the first rim support member, and a wireless connection to the locking mechanism.

In another aspect, there is provided a bicycle, comprising a wheel as defined above.

### BRIEF DESCRIPTIONS OF THE DRAWINGS

For a better understanding of the embodiments described herein and to show more clearly how they may be carried into effect, reference will now be made, by way of example only, to the accompanying drawings in which:

FIG. 1 is a side view of a bicycle equipped with a front wheel having a stabilizing system therein in accordance with an embodiment;

FIG. 2 is an exploded side view of the front wheel of FIG. 1;

FIG. 3 is a perspective view of one side of the front wheel of FIG. 1 after removal of the inner tube and the tyre;

FIG. 4 is a perspective view of the other side of the front wheel of FIG. 3; and

FIG. 5 is a partial section schematic view of the wheel of FIG. 3.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

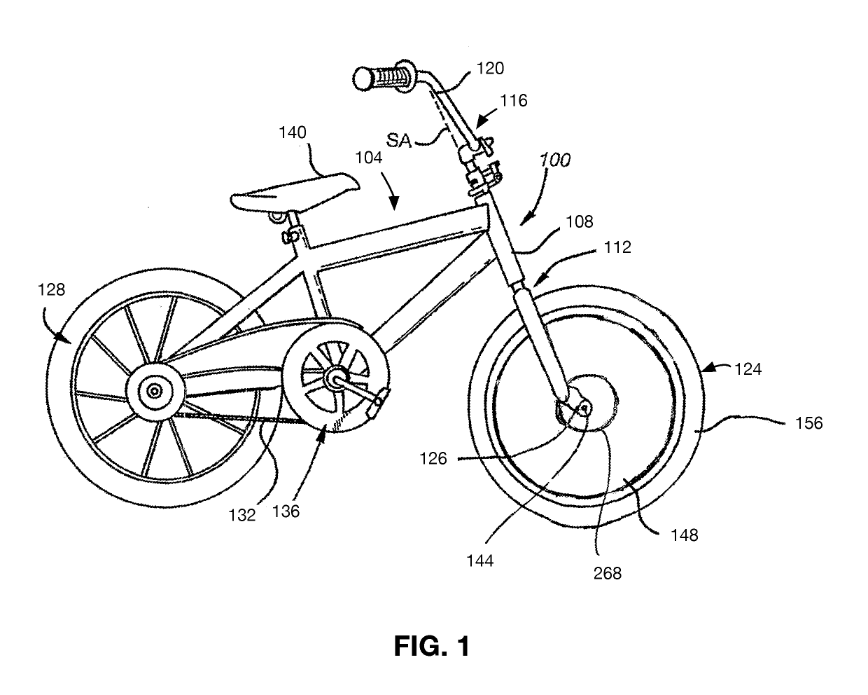

A bicycle 100 having a stabilizing system according to an embodiment is shown in FIG. 1. This bicycle 100 is exemplary of a certain size and style of human-powered two-wheeled vehicle that is particularly adapted for smaller children. The term “bicycle” as used herein is intended to refer to any type of two-wheeled vehicle (including certain powered vehicles) that would benefit from the front-wheel gyroscopic stabilizing effect to be described herein.

The bicycle 100 includes a flywheel inside of the front wheel that can be readily removed and redeployed as desired. Use of the flywheel can assist with balance and turning for a less-experienced rider. There are times, after a user has learned to ride or when a fully trained adult is not in need of the stability offered by the flywheel, when the flywheel's weight is unnecessary and the flywheel's removal will make the entire bicycle lighter and enhance the user's and the bicycle's performance. As used herein, “flywheel” means any rotating mass that is used to resist changes in rotational speed by its moment of inertia. Flywheels can be disk-shaped, or any other suitable dimension.

The bicycle 100 includes a bicycle frame 104 that typically is constructed from a set of tubular members that are joined together. The tubular members are typically made of a metal, such as steel, aluminum, or titanium, but may also be constructed from other materials, such as carbon fibre, moulded plastic, etc. A head tube 108 of the bicycle frame 104 is open at both ends and rotatably receives a front fork assembly 112 that is coupled to a steering assembly 116. The steering assembly 116 and the front fork assembly 112 are coupled so that turning of the steering assembly 116 about a steering axis SA (that is coaxial with a bore of the head tube 1008) causes the front fork assembly 112 to turn as well. The steering assembly 112 typically includes a pair of handlebars 120 that have grips for a rider to hold. A front wheel 124 is rotatably coupled to fork ends 126 of the front fork assembly 112.

A rear wheel assembly 128 is mounted to the frame 104, and is driven by a chain 132 that is, in turn, operatively connected to a pedal crank assembly 136. A seat 140 is coupled to the bicycle frame 104 at a position to enable a rider to sit on it, operate pedals of the pedal crank assembly 136 with his or her feet, and steer the front wheel 124 by turning the steering assembly 116.

The bicycle 100 stays upright while moving forward by being steered by a rider via the handlebars 120 so as to keep the rider's centre of mass over the wheels. The coordination of pedaling and steering while maintaining one's centre of mass over the wheels takes practice by the rider to achieve. Further, the rider must lean into a turn so that the combined centre of mass of the bicycle 100 and the rider lean into a turn to successfully navigate it. This lean is induced by a method known as counter-steering, which can be performed by the rider turning the handlebars 120 directly with the hands or indirectly by leaning the bicycle 100. A common beginner's error while learning to ride a bicycle is to oversteer; that is, to overturn the front wheel 124 so that the forward momentum of the bicycle acts to pull the bicycle to the outside of the turn, potentially causing the rider and bicycle to lose balance and fall. In order to aid a rider in learning to steer the bicycle 100, it is provided with a stabilizing system.

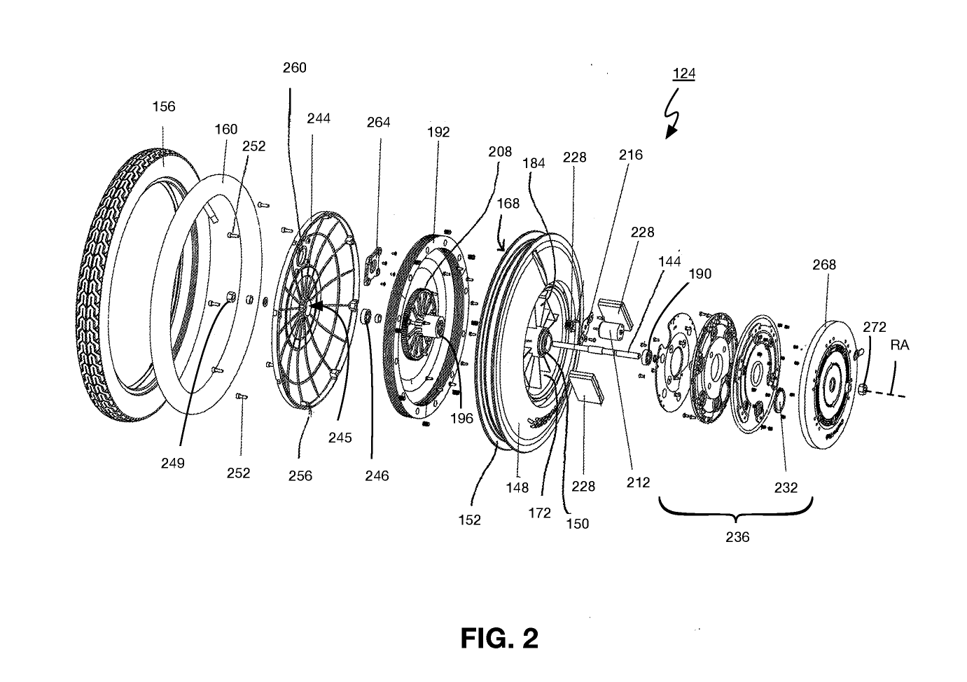

FIG. 2 shows the front wheel 124 exploded along a common lateral axis, the rotation axis RA of the front wheel 124, that is coaxial to an axle 144. The front wheel 124 has a first rim support member 148 having a hub portion 150 that is rotatably mounted on the axle 144. In addition, the first rim support member 148 has a rim portion 152 spaced from its hub portion 150 supporting a tyre 156 and an inner tube 160.

The first rim support member 148 is configured such that it defines at least a part of a flywheel compartment 168 that opens on a first lateral side and an electronics compartment 172 that opens on a second lateral side of the first rim support member 148 opposite the first lateral side. The electronics compartment 172 has an annular shape and is located near and around the hub portion 150 defined by an inner first rim support member portion 176.

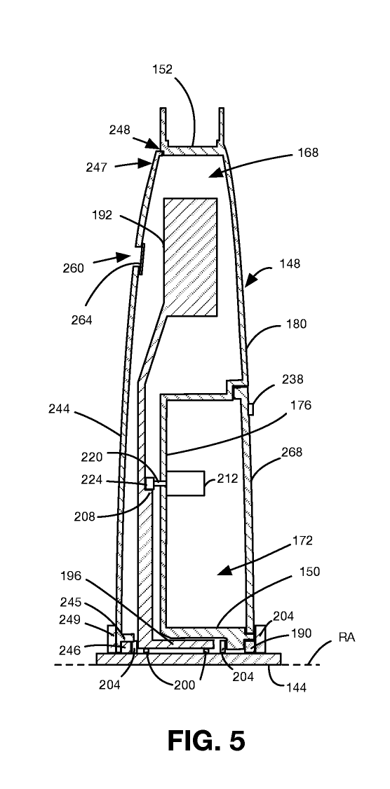

In order to achieve this, the first rim support member 148 has an S-shaped cross-section as shown in FIG. 5. It is to be understood that the view in FIG. 5 is schematic and intended for illustration purposes only.

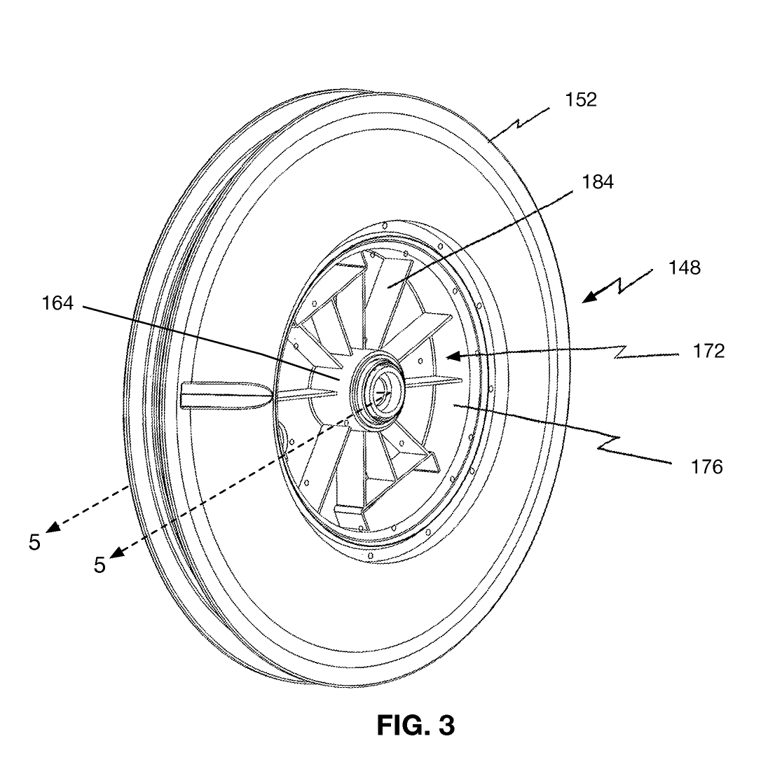

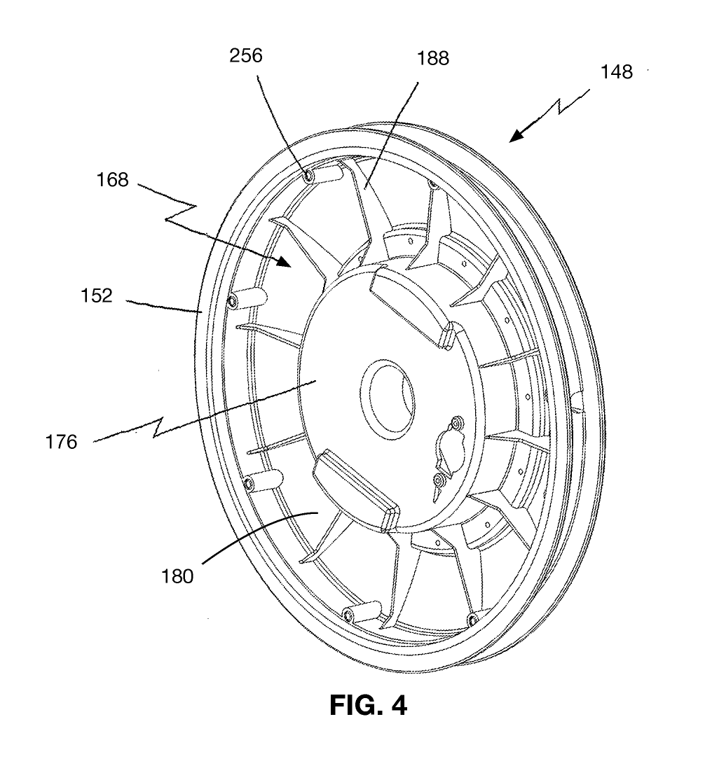

Now referring to FIGS. 1 to 5, ribs 184 extend outwardly radially from the hub portion 150 and along the inner first rim support member portion 176 within the electronics compartment 172. Further, ribs 188 extend outwardly radially from the inner first rim support member portion 176 and along the outer first rim support member portion 180 within the flywheel compartment 168. The ribs 184, 188 are integrally formed with the inner first rim support member portion 176 and the outer first rim support member portion 180. Additionally, the ribs 184, 188 stiffen the first rim support member 148 to counter load forces experienced by the front wheel 124 that act to compress it radially when a rider is riding the bicycle 100. Although integrally formed ribs are used in this embodiment, in other embodiments, the ribs can be secured to the inner first rim support member portion 176 and the outer first rim support member portion 180, or other types of reinforcement, such as thickened portions or the addition of different materials can be employed.

The rim portion 152, outer first rim support member portion 180, the inner first rim support member portion 176, and the hub portion 150 of the first rim support member 148 are integrally formed. In this way, the first rim support member 148 is formed as a single structural element that provides the primary load-bearing element of the front wheel 144. The first rim support member 148 may be formed by moulding or casting, or machining from a single billet on material. In a preferred method of manufacture, the first rim support member 148 is made from polyamide and formed by moulding. It will however be appreciated that any suitable material may be employed, or that the first rim support member 148 can be constructed from multiple elements.

The hub portion 150 of the first rim support member 148 is mounted on a bearing 190 that is, in turn, mounted on the axle 144, allowing the first rim support member 148 to rotate freely about the axle 144.

A removable flywheel 192 that has a hub portion 196 extending from it is positioned in a nested manner next to the first rim support member 148. The hub portion 196 has an outer diameter that fits within a bore of the hub portion 150 of the first rim support member 148. Bearings 200 between the hub portion 196 and the axle 144 enable free rotation of the flywheel 192 relative to the axle 144. Axial shifting of the hub portion 196 along the axle 144 is restricted by clips 204 or some other suitable retaining means, such as nuts.

The flywheel 192 has a toothed annular projection 208 on the surface adjacent the hub portion 196 that has teeth along its circumferential periphery.

The electronics compartment 172 houses flywheel drive and control means. In particular, an electric motor 212 is mounted via a motor mount 216 to the inner first rim support member portion 176 of the first rim support member 148. The electric motor 212 rotatably drives a drive shaft 220 that extends through an aperture in the first rim support member 148 and into the flywheel compartment 168. A flywheel engagement gear 224 is secured on a distal end of the drive shaft 220 within the flywheel compartment 168. The flywheel engagement gear 224 has teeth that correspond to teeth about the toothed annular projection 208 on the flywheel 192, and is positioned to engage and drive the flywheel 192. A pair of batteries 228 provide power to the electric motor 212.

In addition to the electric motor 212 and batteries 228, associated ancillary components such as hardware, circuitry, supervisory electronics and controllers used for the powering and controlling the flywheel 192 in use, as well as an audio speaker 232 by means of which audio instructions for the installation and removal process of the flywheel 192 are provided to a user, are housed with the electronics compartment 172. Such associated hardware, circuitry and controllers, supervisory electronics and speaker may form part of a module or control unit 236.

The electric motor 212 is actuated via a physical control switch 238 located on a surface of the wheel 124, but may alternatively be actuated by a wired connection to a locking mechanism securing the first cover to the first rim support member, and a wireless connection to the locking mechanism.

A second rim support member 244 has a hub portion 245 that is rotatably mounted on the axle 144 via a bearing 190.

A second rim support member 244 is dimensioned to enclose and seal the flywheel 192 within the flywheel compartment 168 defined by it and the first rim support member 148 to restrict access to the flywheel 192. The flywheel compartment 168 has a dish shape with a thickened periphery, and extends from the axle 144 outwardly radially past the electronics compartment 172 and towards the rim portion 152 as defined by an outer first rim support member portion 180. A hub portion 245 of the second rim support member 244 is releasably rotatably mounted on the axle 144 via a bearing 246. The second rim support member 244 is parabolic in shape and has a circular peripheral lip 247 along its periphery. The circular peripheral lip 247 snugly fits within and abuts a retaining wall 248 along the edge of the rim portion 152. A nut 249 is screwed onto the axle 144 to axially compress the second rim support member 244 against the first rim support member 148. As the second rim support member 244 is compressed, the circular peripheral lip 247 is pushed against the retaining wall 248 to secure the second rim support member 244 relative to the first rim support member 148. The parabolic shape of the second rim support member 244 acts to resist deformation during axial compression. Further, it also allows for additional room within the flywheel compartment 168 defined between the first rim support member 148 and the second rim support member 244.

Although, in this embodiment, a retaining feature in the form of the retaining wall 248 is employed, in other embodiments, other retaining features can be employed. For example, retaining posts projecting from the first rim support member 148 and spaced about its periphery adjacent the rim portion 152 can be employed.

In addition, a set of radial and circumferential ribs are formed on an inner surface of the second rim support member 244 to further stiffen it.

The second rim support member 244 is additionally secured to the first rim support member 148 via a set of screws 252 extending through a set of peripheral through-holes 256 in the circumferential periphery of the second rim support member 244. While screws are used to releasably secure the second rim support member 244 to the first rim support member 148, any other suitable means for releasably securing the second rim support member 244 to the first rim support member 148 can be employed, such as bolts, clips, etc. Further, while the second rim support member 244 is secured to the first rim support member 148 via both axial compression forcing the circular peripheral lip 247 against the retaining wall 248 and the screws 252, it will be understood that in other embodiments that either approach alone for securing the second rim support member 244 to the first rim support member 148 may be sufficient.

Conveniently, the second rim support member 244 is provided with a viewing aperture 260 having an at least somewhat transparent insert 264 that enables a user to view the flywheel 192 when the second rim support member 244 is secured to the first rim support member 148. In this way, the user can visually confirm the presence of the flywheel 192, and can determine whether or not the flywheel 192 is rotating. The ability to determine if the flywheel 192 is rotating helps a user to identify whether or not it is safe to remove the second rim support member 244 to expose the flywheel 192. The at least somewhat transparent insert 264 can be opaque or transparent.

An electronics compartment cover 268 is dimensioned to enclose and seal the electric motor and other electronic components, such as the batteries 228, the speaker 232 and the control unit 236 to protect them from the elements and from accidental or malicious damage, as well as protecting people and animals from the electronic components themselves. The electronic disc cover 268 is also parabolic in shape to allow for additional room within the electronics compartment 172 and provide structural strength to the electronics compartment cover 268. In addition, a set of radial and circumferential ribs are formed on an inner surface of the second rim support member 244 (not shown) to further stiffen the electronics compartment cover 268. A central aperture in the electronics compartment cover 268 is dimensioned to enable its fitting over the axle 144.

The electronics compartment cover 268 is releasably secured to the first rim support member 148 via a nut 272 screwed on the axle 144 after its placement thereon. Contact around the peripheral edge of the electronics compartment cover with the perimeter of the electronics compartment 172 enables the electronics compartment cover 268 to provide structural strength and rigidity generally evenly about its circumference to the first rim support member 148 and thus the wheel 124. While, in this embodiment, the electronics compartment cover 268 is secured to the first rim support member 148 via a nut 272 mounted on the axle 144, any other suitable means for releasably securing the electronics compartment cover 268 to the first rim support member 148 can be employed, such as screws, bolts, clips, etc.

The wheel assembly 124 allows the flywheel 192 to be removed and replaced without exposing the electronic components housed in the electronics compartment 172 of the wheel assembly 124, thereby protecting both the electronic components and the person removing the flywheel 192.

In order to remove the flywheel 192 from the wheel 124, the nut 249 is loosened and removed from the axle 144, and the screws 256 securing the second rim support member 244 to the first rim support member 148 are removed. The removal of the nut 249 and the screws 256 allows the second rim support member 244 to be separated from the first rim support member 148. The bearing 246 is then removed from the axle 144. Upon removal of the bearing 246, the flywheel 192 can be withdrawn from the flywheel compartment 168, thereby releasing the flywheel 192 from the gear 224 coupled to the motor 212. Upon withdrawal of the flywheel 192, the bearing 246 can be repositioned over the axle 144. The second rim support member 244 can then be placed over the bearing 246 and re-secured to the first rim support member 148 to re-close the flywheel compartment 168. The nut 249 is refitted on the axle 144 and provide structural rigidity to the wheel 124 and to secure the second rim support member 244 about its periphery to the first rim support member 148.

The process of re-deploying the flywheel 192 within the wheel assembly 124 follows similar steps, except that the flywheel 192 is re-fitted back atop of the bearings 200.

The wheel 124 and the bicycle 100 can thus be readily adapted to have the flywheel 192 installed or removed. This modular arrangement enables the flywheel 192 to be removed by removing a portion of the rim support without the need to remove the tyre 156. Further, the structure of the wheel 124 enables this to be performed without exposure of and to the electronic elements of the wheel assembly 124.

The first rim support member 148 and the second rim support member 244 when secured in place provide a stable wheel structure for supporting the tyre 156 atop of the axle 144. The securing of the second rim support member 244 to the first rim support member 148 along their periphery and their coupling to the axle 144 with limited axial movement therealong enables the flywheel compartment 168 to be sealed to prevent contact by a person or other objects with the flywheel 192.

Similarly, the batteries 228 can be replaced or the motor 212 and other electronic components such as the control unit 236 can be serviced by unfastening the nut 272 from the axle 144, and then removing the electronics compartment cover 268.

The installation and removal process can be embodied in any conceivable use of widely available and novel electro-mechanical and electronic means whether controlled by firmware or software, for the purpose of simplicity, convenience and safety. The installation and removal process anticipates but does not require the use of lights and sounds guiding users through the installation and removal process. Audible installation and removal instructions are provided to a user via the speaker 232. The audio speaker 232 is also usable so that other sounds, such as, for example, music, tones, or words of encouragement, can be played for the benefit of a user or bystanders. Preferably, the speaker 232 is waterproof so that operation is unaffected by adverse wet conditions. Also as described previously, the speaker 232 may be provided as part of the control module or hub 236 that is mountable on the wheel 124 within the electronics compartment 172, and which may also include circuitry, controllers, supervisory electronics for powering and controlling the flywheel in use.

It will be appreciated that the wheel 124 may further comprise a programmable or intelligent control means for controlling the flywheel 192 and thus its associated gyroscopic effect.

The skilled man can see that the wheel and the support cover may have any suitable size, shape, design and dimensions, generally able to provide support for and at least some covering on each side of the flywheel. The shape, size or design of the wheel and the support cover.

The support cover shape and dimensions can be varied. It is desirable in most embodiments that the support cover is secured to the first rim support member close to its periphery, preserving sufficient room in the flywheel compartment for the flywheel to rotate unimpeded. For example, the support cover may be any one of a number of polygonal shapes, starfish shaped, etc.

The support cover and the first rim support member can be partially open to show the rotation of the flywheel in some embodiments. The flywheel may be decorated in a manner that is entertaining when viewed through the opening(s) of the support cover and the first rim support member.

The size, shape, dimensions or design of the first rim support member and the second rim support member can be varied. For example, the first rim support member and the second rim support member can be parabolic, frustoconical, or any other suitable shape.

While, in the above described embodiment(s), the rim portion forms part of the first rim support member, in other embodiments, the rim portion can form part of the second rim support member, can be separately provided, or can be formed by elements of the first rim support member and the second rim support member.

The retaining feature(s) (e.g., the retaining wall in the above-described embodiment) can be provided by the second rim support member, with the first rim support member fitting therein. In this case, it may be preferable to have the rim portion extend from the second rim support member. Further, the retaining feature(s) in other embodiments can be other protruding features, such as posts, or any other suitable feature for the opposing rim support member to be constrained by at least radially.

In a similar manner, the flywheel may have any shape, size or design, generally being symmetric about at least one central axis so as to provide precession.

Also, the location of the flywheel relative to the symmetry of the wheel, in particular the symmetry of the wheel axle. That is, the flywheel may be locatable co-axially with the rotation axis of the wheel, or non-co-axially, whilst still providing the precession effect when the wheel is in motion.

While the location of the flywheel drive motor, the power source, and the other electrical components is within a separate compartment in the above-described embodiment, it will be appreciated that, in other embodiments, one or more of these components can be placed in the same compartment as the flywheel. In still further embodiments, a separate electronics compartment can be omitted.

In another embodiment of the present invention, the fasteners can include one or more security mechanisms to prevent their easy unfastening, and thus any unintentional or accidental unfastening. Such security mechanisms may include the shape, size, design and/or pattern of the fasteners, such as bolts having special security engagements such as distinct shaped heads or slots, depressions etc., or one or more locking mechanisms preventing unfastening of the fasteners without unlocking the locking mechanism. Such locking mechanisms may be physical, electronic, or both, and may include one or more alarms indicating the unlocking or preparation for unlocking of the fasteners, and/or one or more safety plug inserts.

In particular, it is preferred that any such locking mechanism includes an electronic code required to be properly entered to allow separation of the parts of the casing (i.e., the wheel and support cover) in a safe manner prior to removal of the flywheel. Such locking mechanisms may be activated by one or more devices located on the wheel, or via a wired or wireless connection to said locking mechanisms.

The mounting orientation of the flywheel is made certain by a system of marks, seats and notches. The mass may be fixed in the wheel and therefore rotate with the wheel or it may be mounted to an assembly that allows the mass to spin independently of the bicycle wheel.

For the purpose of orientating the mass, a system of seatings, marks and optionally notches of any number or shape can be implemented to orient the flywheel should flywheel orientation provide any benefit.

For the purpose of making the removal process of the movable mass depend on the availability of a special purpose tool, the removal process may utilize fasteners of a type that require a special purpose tool such as screws with unique screw slottings. In this way, the unauthorized access to the flywheel within the wheel is mitigated.

For the purpose of providing additional capability supporting the installation and removal process, the process may involve electro-mechanical devices like solenoid actuators and/or electronics that, with the installation or removal process underway, change the operation of the wheel so that normal operation is not possible (e.g., rotation of flywheel cannot be activated during the installation and removal process).

While, in the above described and illustrated embodiments, the wheels having the above-described features are deployed on human-powered bicycles, such wheels can be deployed on other types of human-powered vehicles, such as, for example, tricycles and electrically driven bicycles.

Persons skilled in the art will appreciate that there are yet more alternative implementations and modifications possible, and that the above examples are only illustrations of one or more implementations. The scope, therefore, is only to be limited by the claims appended hereto.

1. A wheel for a vehicle, comprising:
a first rim support member having a first hub portion rotatably mounted on an axle;
a second rim support member having a second hub portion releasably rotatably mounted on the axle, the second rim support member being releasably secured to the first rim support member along a region spaced from the axle;
a rim portion extending from at least one of the first rim support member and the second rim support member and configured to support a tyre thereon; and
a flywheel positioned between the first rim support member and the second rim support member and having a flywheel hub portion releasably rotatably mounted on the axle between the first hub portion and the second hub portion.

2. A wheel according to claim 1, wherein the rim portion extends from the first rim support member.

3. A wheel according to claim 2, wherein the rim portion is integrally formed with the first rim support member.

4. A wheel according to claim 3, wherein the second rim support member is releasably secured to the first rim support member adjacent the rim portion.

5. A wheel according to claim 1, wherein the second rim support member is releasably secured to the first rim support member via at least one fastener adjacent the rim portion.

6. A wheel according to claim 1, wherein one of the first rim support member and the second rim support member has at least one retaining feature within which the other of the first rim support member and the second rim support member fits and abuts.

7. A wheel according to claim 6, wherein the first rim support member comprises the at least one retaining feature, and wherein the at least second rim support member is releasably secured to the first rim support member via axial compression.

8. A wheel according to claim 7, wherein the axial compression is provided by a nut screwed on the axle.

9. A wheel according to claim 1, further comprising:
a motor coupled to the flywheel to control rotation of the flywheel about the axle.

10. A wheel according to claim 9, wherein the motor is secured to one of the first rim support member and the second rim support member, and is releasably coupled to the flywheel.

11. A wheel according to claim 1, wherein the second rim support member is secured to a first side of the first rim support member, and wherein the first rim support member has a recess on a second side opposite the first side.

12. A wheel according to claim 11, further comprising:
a recess cover configured to enclose the recess.

13. A wheel according to claim 12, further comprising:
a motor located in the recess and coupled to the flywheel to control rotation of the flywheel about the axle; and
a drive transmission extending from the motor, through the first rim support member, and to the flywheel to drive the flywheel.

14. A wheel according to claim 12, further comprising:
an audio speaker located in the recess.

15. A wheel according to claim 14, further comprising:
a processor configured to play audio instructions for removal of the flywheel via the audio speaker.

16. A wheel according to claim 1, wherein at least one of the first rim support member and the second rim support member has a viewing aperture enabling viewing of the flywheel when positioned between the first rim support member and the second rim support member.

17. A wheel according to claim 16, wherein the viewing aperture is covered by an at least somewhat transparent material.

18. A wheel according to claim 9, wherein the motor is actuated via at least one of a physical control switch located on a surface of the wheel, a wired connection to a locking mechanism securing the first cover to the first rim support member, and a wireless connection to the locking mechanism.

19. A bicycle, comprising a wheel according to claim 1.
